(19) United States
(12) Patent Application Publication
(10) Pub. No.: US 2008/0290727 A1
(43) Pub. Date: Nov. 27, 2008

(54) Method for Controlling an Electromagnetic Retarder

(76) Inventors: Bruno Dessirier, Saint Germain en Laye (FR); Stephane Hailly, Issy Les Moulineaux (FR); Serge Newiadomy, Clichy Sous Bois (FR)

Correspondence Address: BERENATO, WHITE & STAVISH, LLC, 6550 ROCK SPRING DRIVE, SUITE 240, BETHESDA, MD, 20817, US

(21) Appl. No.: 12/092,144

(22) PCT Filed: Dec. 15, 2006
(86) PCT No.: PCT/FR2006/002749

§ 371 Date: Jul. 7, 2008

(30) Foreign Application Priority Data
Dec. 22, 2005 (FR) 0554045

(51) Int. Cl. B60T 13/74; H02P 3/06

(52) U.S. Cl. 303/20; 318/375

(57) ABSTRACT

A method for controlling an electromagnetic retarder. More specifically, the method relates to determining, in a control unit, a maximum allowable intensity (Im) of an excitation current to be injected into an electromagnetic retarder (1). The retarder includes a shaft bearing secondary windings (5) and field coils (13) which are supplied by the secondary windings (5), the primary coils (8) and secondary windings (5) forming a generator. The retarder also includes a jacket (9) inside which the field coils (13) generate Foucault currents and a circuit for the liquid cooling of said jacket. The method consists in determining the maximum intensity in real time from data and values that are representative of the speed of rotation of the rotary shaft, the heat load that the cooling circuit can dissipate and the flow rate (D) of the coolant. The method is suitable for electromagnetic retarders which are intended for vehicles such as heavy vehicles.

### FIELD OF THE INVENTION

The invention concerns a method of controlling an electromagnetic retarder comprising a current generator including primary coils into which an excitation current is injected.

The invention applies to a retarder capable of generating a retarding resisting torque on a main or secondary transmission shaft of a vehicle that it equips, when this retarder is actuated.

### PRIOR ART

Such an electromagnetic retarder comprises a rotary shaft that is coupled to the main or secondary transmission shaft of the vehicle in order to exert on it the retarding resisting torque in particular for assisting the braking of the vehicle.

The retarding is generated with field coils supplied with DC current in order to produce a magnetic field in a metal piece made from ferromagnetic material, in order to make eddy currents appear in this metal piece.

The field coils can be fixed so as to cooperate with at least one metal piece made from movable ferromagnetic material having the general appearance of a disc rigidly secured to the rotary shaft.

In this case, these field coils are generally oriented parallel to the rotation axis and disposed around this axis, facing the disc, while being secured to a fixed plate. Two successive field coils are supplied electrically in order to generate magnetic fields in opposite directions.

When these field coils are supplied electrically, the eddy currents that they generate in the disc through their effects oppose the cause that gave rise to them, which produces a resisting torque on the disc and therefore on the rotary shaft, in order to slow down the vehicle.

In this embodiment, the field coils are supplied electrically by a current coming from the electrical system of the vehicle, that is to say for example from a battery of the vehicle. In order to increase the performance of the retarder, recourse is had to a design in which a current generator is integrated in the retarder.

Thus, according to another design known from the patent documents EP0331559 and FR1467310, the electrical supply to the field coils is provided by a generator comprising primary stator coils supplied by the vehicle system, and secondary rotor coils fixed to the rotating shaft.

The field coils are then fixed to the rotating shaft while being radially projecting, so that they turn with the rotary shaft in order to generate a magnetic field in a fixed cylindrical jacket that surrounds them.

A rectifier such as a diode bridge rectifier is interposed between the secondary rotor windings of the generator and the field coils, in order to convert the alternating current delivered by the secondary windings of the generator into a DC current supplying the field coils.

Two radial field coils consecutive around the rotation axis generate magnetic fields in opposite directions, one generating a field oriented centrifugally, the other a field oriented centripetally.

In operation, the electrical supply to the primary coils enables the generator to produce the supply current to the field coils, which gives rise to eddy currents in the fixed cylindrical jacket so as to generate a resisting torque on the rotary shaft, which slows the vehicle.

In order to reduce the weight and increase further the performance of such a retarder, it is advantageous to couple it to the transmission shaft of the vehicle by means of a speed multiplier, in accordance with the solution adopted in the patent document EP1527509.

The rotation speed of the retarder shaft is then multiplied compared with the rotation speed of the transmission shaft to which it is coupled. This arrangement significantly increases the electrical power delivered by the generator and therefore the power of the retarder.

### OBJECT OF THE INVENTION

The aim of the invention is a method of determining the maximum acceptable intensity of the excitation current for the primary coils of an electromagnetic retarder enabling the performance and reliability thereof to be improved.

To this end, the object of the invention is a method for determining, in a control box, a maximum acceptable intensity (Imax) of an excitation current to be injected into primary stator coils of an electromagnetic retarder comprising a rotary shaft carrying secondary windings and field coils supplied electrically by these secondary windings, the primary coils and the secondary windings forming a generator, this retarder comprising a fixed cylindrical jacket surrounding the field coils and in which the field coils generate eddy currents, and a cooling circuit with circulation of liquid in this jacket, this method consisting of determining the maximum intensity in real time from measurements representing the speed of rotation (Na) of the rotary shaft, the heat output that the cooling circuit is capable of dissipating, and the flow rate of the cooling liquid, these data coming from sensors connected to the control box.

The optimisation in real time of the intensity of the excitation current that is injected into the primary coils according to the operating conditions of the retarder makes it possible to increase the braking torque. It makes it possible to integrate various distinct operating constraints in order to determine a maximum acceptable current intensity that is optimum at each moment in the light of the thermal operating conditions of the retarder.

The invention also concerns a method as defined above in which the measurements representing the heat output that the cooling circuit is capable of dissipating comprise a difference value between the temperature of the cooling liquid at the inlet and outlet of the cooling circuit and a value representing the flow rate of the cooling liquid.

The invention also concerns a method as defined above consisting of determining a first intensity from the speed of rotation of the rotary shaft, a second intensity from the heat output that the cooling circuit is capable of dissipating, and a third intensity from the flow rate of the cooling liquid, and attributing to the maximum acceptable intensity the smallest value from the first, second and third intensities.

The invention also concerns a method as defined above in which the maximum acceptable intensity is determined in the control box from tables of numerical values stored in this control box, these tables comprising values representing the maximum acceptable current for different operating conditions.

The invention also concerns a method as defined above in which the values are stored in the form of a dynamic two-way table.

The invention also concerns a method as defined above consisting of determining the value representing the flow rate of cooling liquid from the speed of a thermal engine of the vehicle and a nomogram characteristic of a water pump driven by this thermal engine, this water pump causing the circulation of the cooling liquid.

The invention also concerns a method as defined above in which the value signifying the speed of the thermal engine issues from data transmitted by a CAN bus.

### BRIEF DESCRIPTION OF THE DRAWINGS

The invention will now be described in more detail and with reference to the accompanying drawings, which illustrate an embodiment thereof by way of non-limitative example.

FIG. 1 is an overall view with a local cutaway of an electromagnetic retarder to which the invention applies;

FIG. 2 is a schematic representation of the electrical components of the retarder to which the method according to the invention is applied;

FIG. 3 is a curve representing the acceptable intensity as a function of the speed of rotation of the rotary shaft;

FIG. 4 is a curve representing the critical jacket temperature as a function of the flow rate of cooling liquid.

### DESCRIPTION OF EMBODIMENTS OF THE INVENTION

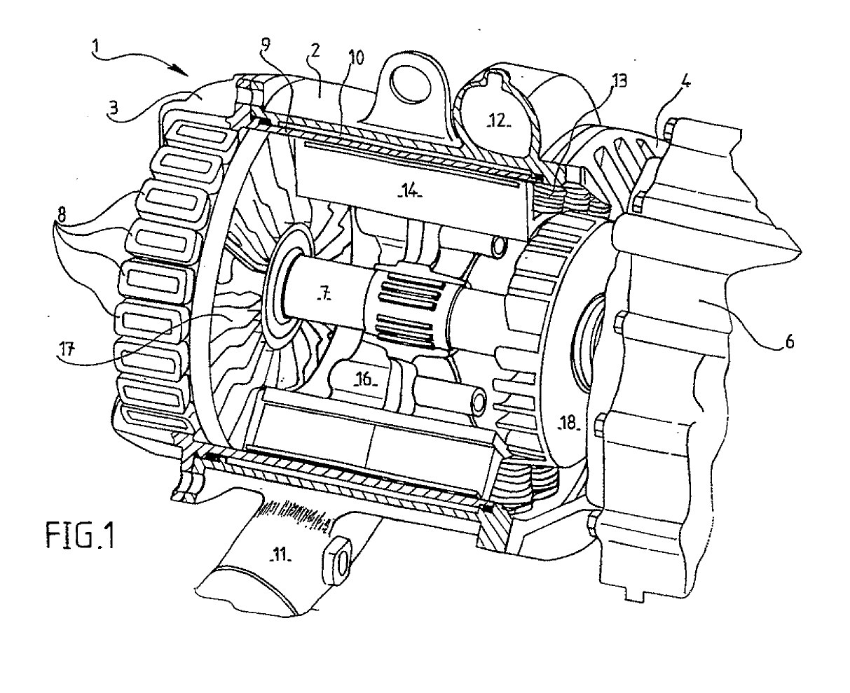

In FIG. 1, the electromagnetic retarder 1 comprises a main casing 2 with a cylindrical shape overall having a first end closed by a cover 3 and a second end closed by a coupling piece 4 by means of which this retarder 1 is fixed to a gearbox casing either directly or indirectly, here via a speed multiplier referenced 6.

This casing 2, which is fixed, encloses a rotary shaft 7 that is coupled to a transmission shaft, not visible in the figure, such as a main transmission shaft to the vehicle wheels, or secondary such as a secondary gearbox output shaft via the speed multiplier 6. In a region corresponding to the inside of the cover 3 a current generator is situated, which comprises fixed or stator primary coils 8 that surround rotor secondary windings, secured to the rotary shaft 7.

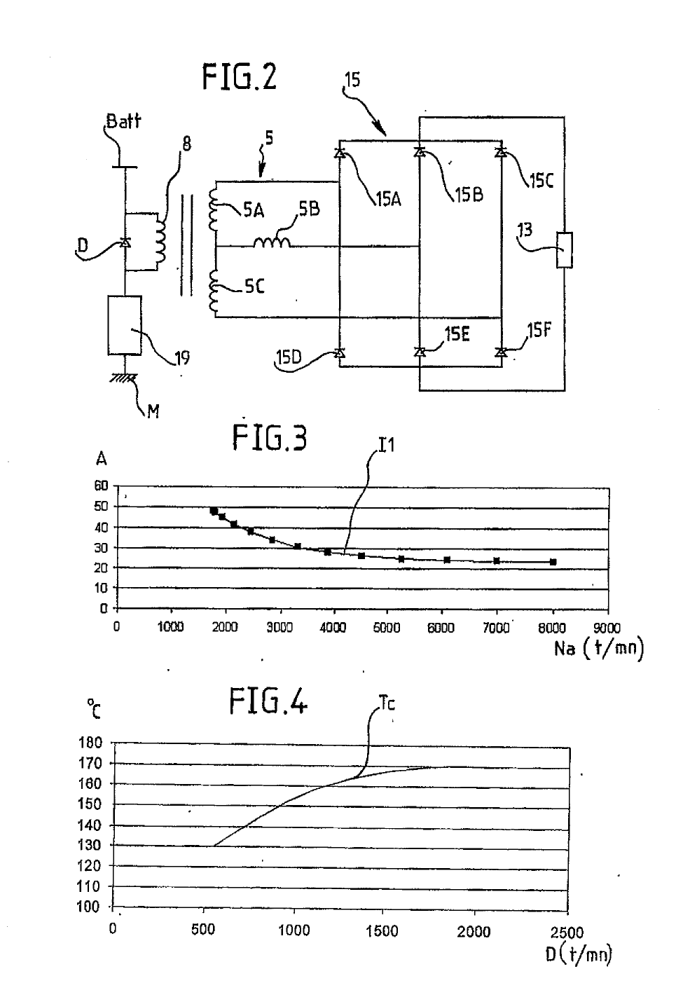

These secondary windings are shown symbolically in FIG. 2, being marked by the reference 5. These secondary windings 5 comprise here three distinct windings 5a, 5b and 5c in order to deliver a three-phase alternating current having a frequency dependent on the speed of rotation of the rotary shaft 7.

An internal jacket 9, cylindrical in shape overall, is mounted in the main casing 2, being slightly spaced apart radially from the external wall of this main casing 2 in order to define a substantially cylindrical intermediate space 10 in which a cooling liquid of this jacket 9 circulates.

This main casing, which also has a cylindrical shape overall, is provided with a channel 11 for admitting cooling liquid into the space 10 and a channel 12 for discharging cooling liquid out of this space 10.

The cooling circuit of the retarder can be connected in series with the cooling circuit of the thermal engine of the vehicle that this retarder equips. In this case, the inlet 11 is connected to the outlet from the thermal engine, the outlet 12 being connected to the inlet of a cooling radiator of this circuit.

This jacket 9 surrounds several field coils 13, which are carried by a rotor 14 rigidly fixed to the rotary shaft 7. Each field coil 13 is oriented so as to generate a radial magnetic field while having an oblong shape overall extending parallel to the shaft 7.

In a known fashion, the jacket 9 and the body of the rotor 14 are made from ferromagnetic material. Here the casing is a castable piece based on aluminium and sealing joints intervene between the casing and jacket 9; the cover 3 and the piece 4 are perforated.

The field coils 13 are supplied electrically by the rotor secondary windings 5 of the generator via a bridge rectifier carried by the rotary shaft 7. This bridge rectifier can be the one that is marked 15 in FIG. 2 and that comprises six diodes 15A-15F, in order to rectify the three-phase alternating current issuing from the secondary windings 5A-5D into direct current. This bridge rectifier can also be of another type, being for example formed from transistors of the MOSFET type.

As can be seen in FIG. 1, the rotor 14 carrying the field coils 13 has the overall shape of a hollow cylinder connected to the rotary shaft 7 by radial arms 16. This rotor 14 thus defines an annular internal space situated around the shaft 7, this internal space being ventilated by an axial fan 17 situated substantially in line with the junction of the cover 3 with the casing 2. A radial fan 18 or a deflector is situated at the opposite end of the casing 2 in order to discharge the air introduced by the fan 17.

The action on the retarder consists of supplying the primary coils 8 with an excitation current coming from the electrical system of the vehicle and in particular from the battery, so that the generator delivers the current at its secondary windings 5. This current delivered by the generator then supplies the field coils 13 so as to generate any currents in the fixed cylindrical jacket 9 in order to produce a resisting torque providing the retarding of the vehicle. The excitation current is injected into the primary coils 8 by means of a control box described below.

The electric power delivered by the secondary windings 5 of the generator is greater than the electric power supplying the primary coils 8 since it is the result of the magnetic field of the primary coils 8 and the work supplied by the rotary shaft. In the embodiment in FIG. 1, the shaft 7 of the retarder is connected to the transmission shaft of the vehicle wheels via the multiplier 6 acting on a secondary shaft of the gearbox connected to the main shaft thereof.

This retarder comprises a control box 19 shown in FIG. 2, which is interposed for example between an electrical supply source of the vehicle, and the primary coils 8. In the example in FIG. 2, the control box 19 and the primary coils 8 are connected in series between an earth M of the vehicle and a supply Batt of the vehicle battery. As can be seen in this figure, a diode D is connected at the terminals of the primary coils 8 so as to prevent the circulation of a reverse current in the primary coils.

The control box 19 of the retarder is an electronic box comprising for example a logic circuit of the ASIC type functioning at 5V, and/or a power control circuit capable of managing high-intensity currents.

This control box 19 comprises an input able to receive a control signal from the retarder, representing a retarding torque level demanded of the retarder. The control box 19 determines in real time a maximum intensity Imax acceptable for the current to be injected into the primary coils 8. It next defines the level of the intensity Ie of excitation current, from the maximum intensity Imax and the value taken by the control signal.

The maximum acceptable intensity Imax of the excitation current Ie to be injected into the primary coils is determined in the control box 19 in real time from data and measurements representing the speed of rotation of the rotary shaft 7, the heat output that the cooling circuit is capable of dissipating and the flow rate of the cooling liquid.

The control box 19 first of all determines three intensities, denoted respectively I1, I2 and I3, corresponding to three distinct criteria, and attributes to Imax the lowest of the three values I1, I2 and I3.

These three intensities I1, I2 and I3 correspond to three distinct conditions to be complied with.

The first intensity I1 is a threshold value of the excitation current, beyond which the current If flowing in the field coils 13 is too high and causes damage to the field coils 13 or to the bridge rectifier 15, or the secondary windings 5A-5C. This first intensity I1 depends mainly on the speed Na of rotation of the rotary shaft 7 since, for the same excitation current value Ie injected into the primary coils, the intensity of the current If flowing in the field coils 13 increases with the speed of rotation Na of the shaft 7.

The intensity I2 is a threshold value beyond which the heat output generated by the eddy current is greater than the heat output that the cooling circuit is capable of discharging. If the intensity of the excitation current Ie is greater than I2, the cooling liquid starts to boil.

The intensity I3 is a threshold value beyond which the temperature of the cylindrical jacket 9 is too high and also causes the cooling liquid to start to boil even if the latter is capable of discharging the heat output generated by the eddy currents.

The intensity I1 is determined by reading from a data table stored in the control box 19, which comprises, for various values of the rotation speed Na, the acceptable intensity for the excitation current Ie. This table corresponds to the graph in FIG. 3, representing the acceptable current Ie according to the speed Na, and which is a decreasing curve with horizontal asymptote.

The rotation speed Na of the rotary shaft 7 can come from a rotation speed sensor equipping the retarder or be deduced from data available on a CAN data bus of the vehicle to which the box 19 is connected. In this case, the speed multiplication factor 6 is stored in the control box 19 to enable the speed Na to be determined from the data of the CAN bus.

The second intensity I2 is determined from data and measurements representing the heat output that the liquid cooling circuit is capable of dissipating, so as to give rise to eddy currents generating a heat output corresponding to the heat output that the cooling circuit is capable of dissipating.

This heat output is determined principally by a difference, denoted DT, between the temperature of the cooling liquid at the inlet 11 to the retarder and at the outlet 12 from the retarder and by the flow rate, denoted D, of the cooling liquid in the retarder. The heat output that the cooling circuit can dissipate is higher, the greater the difference DT and the flow rate D.

The temperature difference DT is determined from two thermal probes placed respectively at the inlet 11 and outlet 12 of the cooling circuit, these probes being connected to the control box 19.

The flow rate D of the cooling liquid corresponds to the speed of rotation of a water pump driven by the thermal engine of the vehicle and which causes the circulation of the liquid in the cooling circuit. The flow rate D results from the rotation speed of the thermal engine denoted Nt, and from a nomogram representing the characteristic of this pump. The control box 19 recovers the rotation speed Nt on the CAN bus in order to determine the flow rate D from the nomogram of the pump stored in this control box 19.

The heat output to be dissipated by the liquid cooling circuit corresponds mainly to the heat output issuing from the eddy currents flowing in the cylindrical jacket 9. The latter is directly related to the intensity of the current, denoted If, that flows in the field coils 13. This current If has itself an intensity dependent on the rotation speed Na of the rotary shaft 7 and the intensity of the excitation current Ie.

The determination of the second intensity I2 consists of first of all of identifying a threshold value of the current If flowing in the field coils beyond which the heat output generated by the eddy currents would be greater than the heat output that the liquid cooling circuit is capable of dissipating. This threshold value of the intensity of the current If, which therefore depends on the difference DT and the flow rate D, is for example read in a table of numerical data stored in the control box 19.

From this threshold value of the current If flowing in the field coils and the rotation speed Na of the rotary shaft 7, the value of the second intensity I2 of the excitation current is read in another data table. This other data table indicates the value of Ie for various values of If and Na.

The third intensity I3 corresponds to a condition to be complied with by the temperature of the jacket, which must remain below a critical temperature, denoted Tc, in order not to cause the cooling liquid to start to boil.

This critical temperature Tc depends mainly on the cooling liquid flow rate D, according to a change law depicted on the graph in FIG. 4: the higher the rate D, the higher the critical temperature Tc may be.

When the temperature of the cooling liquid changes around one hundred and five degrees, which corresponds to the graph in FIG. 4, the temperature of the cylindrical jacket 9 depends mainly on the intensity If of the current flowing in the field coils 13.

The determination of this third intensity I3 consists of first of all reading the critical temperature Tc acceptable for the rate D in question in a data table stored in the control box 19, this data table corresponding to the graph in FIG. 4.

The level of the current If flowing in the field coils 13 and corresponding to the critical temperature Tc is then read in another data table that gives, for different critical temperatures Tc, the corresponding level of If, for normal operating conditions, that is to say for a temperature of the cooling liquid close to one hundred and five degrees.

The level of I3 is then determined from the speed Na of the rotary shaft 7 and the current If determined above, by reading from another data table matching Ie and If for different levels of the speed Na.

In the embodiment presented above, the data are stored in the control box 19 in the form of distinct data tables, but these data may be stored in the form of one or more dynamic two-way tables.

This facilitates the implementation of the control method according to the invention while offering flexibility allowing adaptability to different use contexts.

In the above example, the intensities I2 and I3 are determined by referring, in an intermediate fashion, to threshold values of the current If flowing in the inductive coils 13 and determining the intensity of the excitation current I2 or I3 at the required level of If, for the speed Na in question.

It is also possible to implement the method according to the invention by directly determining the levels of I2 and I3 without determining the threshold value of the current If.

The level of I2 can be read directly in a table giving values of I2 from different flow rates D and differences DT. In a similar fashion, the level of I3 can be determined by a direct reading from a data table giving levels of I3 corresponding to different values of the flow rate D.

The invention offers in particular the following advantages:

It makes it possible to increase the level of the excitation current injected into the primary coils in order to obtain a higher retarding torque. Without such regulation, the intensity of the excitation current is limited to a relatively low level corresponding solely to predetermined conditions of use of the retarder.

The invention also makes it possible to increase the reliability and longevity of the retarder by avoiding making it function in a range situated beyond its capabilities.

1. Method for determining, in a control box, a maximum acceptable intensity (Imax) of an excitation current (Ie) to be injected into primary stator coils (8) of an electromagnetic retarder (1) comprising a rotary shaft (7) carrying secondary windings (5) and field coils (13) supplied electrically by these secondary windings (5), the primary coils (8) and the secondary windings (5) forming a generator, said retarder (1) comprising a fixed cylindrical jacket (9) surrounding the field coils (13) and in which the field coils (13) generate eddy currents, and a cooling circuit with circulation of liquid in this jacket, said method comprising the steps of determining the maximum intensity (Imax) in real time from measurements representing the speed of rotation (Na) of the rotary shaft (7), the heat output that the cooling circuit is capable of dissipating (DT, D), and the flow rate (D) of the cooling liquid, these data coming from sensors connected to the control box (19).

2. Method according to claim 1, in which the measurements representing the heat output that the cooling circuit is capable of dissipating comprises a difference value (DT) between the temperature of the cooling liquid at the inlet (11) and outlet (12) of the cooling circuit and a value representing the flow rate (D) of the cooling liquid.

3. Method according to claim 1, comprising the steps of determining a first intensity (I1) from the rotation speed (Na) of the rotary shaft (7), a second intensity (I2) from the heat output that the cooling circuit is capable of dissipating, and a third intensity (I3) from the flow rate of the cooling liquid, and attributing to the maximum acceptable intensity (Imax) the smallest value from the first, second and third intensities (I1, I2, I3).

4. Method according to claim 1, in which the maximum acceptable intensity (Imax) is determined in the control box (19) from tables of numerical values stored in this control box (19), said tables comprising values representing the maximum current (Imax) acceptable for various operating conditions.

5. Method according to claim 4, in which the values are stored in the form of a dynamic two-way table.

6. Method according to claim 1, consisting of determining the value representing the flow rate (D) of cooling liquid from the speed (Nt) of a thermal engine of the vehicle and a nomogram characteristic of a water pump driven by this thermal engine, said water pump causing the circulation of the cooling liquid.

7. Method according to claim 6, in which the value signifying the speed of the thermal engine issues from data transmitted by a CAN bus.
